(19) United States
(12) Patent Application Publication
(10) Pub. No.: US 2026/0158397 A1
(43) Pub. Date: Jun. 11, 2026

(54) GRAPHICAL RESOURCE SHARING FOR TEMPORARY OBJECTS

(71) Applicant: Netflix, Inc., Los Gatos, CA (US)

(72) Inventors: Tony Tin Fook Wong, San Francisco, CA (US); Thomas Engel, Fairfax, CA (US); Julian Eggebrecht, San Rafael, CA (US)

(21) Appl. No.: 18/974,419

(22) Filed: Dec. 9, 2024

(51) Int. Cl. A63F 13/77; G06T 1/20

(52) U.S. Cl. CPC A63F 13/77; G06T 1/20

(57) ABSTRACT

The disclosed computer-implemented method includes determining that a data structure stored in memory is to be shared among other concurrently running application processes managed by an application engine. The method also includes identifying, within the application engine, contextual information specifying details regarding different functions that are operating among the concurrently running application processes. Still further, the method includes determining which data structures are currently shareable between a first application process and a second application process based on the identified contextual information within the application engine and sharing the data structures of the first application process to at least the second application process. Various other methods, systems, and computer-readable media are also disclosed.

### BACKGROUND

Many cloud computing platforms now provide distributed gaming experiences. In cloud gaming scenarios, video game data are typically rendered on remote servers and then transmitted to gaming clients. These gaming client devices then decode and display the video game data. When generating the video game data, the remote servers receive requests from video game applications to store data in temporary memory locations, typically referred to as random-access memory (RAM) or video RAM (VRAM). Because VRAM is very fast, it is also expensive and thus limited in quantity. When running many thousands or even millions of concurrent video game sessions on cloud servers, access to VRAM becomes highly contested. Moreover, simply reusing memory that might overlap between applications becomes problematic when accounting for highly specialized graphics processing units (GPUs) that can access content at virtually any time and without notice.

### SUMMARY

As will be described in greater detail below, the present disclosure describes methods and systems for sharing memory among multiple application instances including, specifically video game instances. In one example, a computer-implemented method includes determining that at least one data structure stored in memory is to be shared among multiple concurrently running application processes managed by an application engine. The method also includes identifying, within the application engine, contextual information specifying various details regarding different functions that are operating among the concurrently running application processes. The method further includes determining which data structures are currently shareable between a first application process and at least a second application process based on the identified contextual information within the application engine and sharing the data structures of the first application process to the second application process.

In some embodiments, the shared data structures are temporary data stored in a temporary buffer used by the application engine. In some examples, sharing the data structures from the first application process to the second application process includes sharing a memory address identifying where the shared data structure is stored. In some cases, determining which data structures are currently shareable between the first application process and the second application process includes identifying processing flags within the application engine.

In some cases, the method further includes instructing the application engine to create flags for data structures that are shareable between application processes. In some embodiments, at least one of the members of the data structures includes a resource identifier or a unique hash identifier. In some examples, the application engine is a video game engine, and the application is a video game. In some cases, the shared data structures are shared between a first instance of the video game and a second instance of the video game running concurrently. In some examples, the shared data structures are shared between a first instance of the video game and multiple additional instances of the video game running concurrently.

In some cases, the contextual information specifying details regarding different functions that are operating among the plurality of concurrently running application processes includes: size of the data, name of the data, type of data, where the data is stored in memory, which buffer the data was created for, which data file the data is part of, or an indication of how the data is used within the application engine.

In some embodiments, the method further includes instructing a driver associated with the application engine to hold on to the shared data structure for at least a specified amount of time before releasing the shared data structure. In some cases, the shared data structure is protected from alterations or corrections from a CPU or GPU for at least a specified amount of time. In some examples, the shared data structures include a stored pool of textures used by the application engine. In some cases, the shared data structures include vertex data that expresses one or more three-dimensional shapes.

In some embodiments, the shared data structures include stream buffers for shared video that is concurrently being played across two or more application instances. In some cases, sharing the data structures of the first application process to at least the second application process occurs in real-time.

In addition, a corresponding system includes at least one physical processor, and physical memory comprising computer-executable instructions that, when executed by the physical processor, cause the physical processor to: determine that at least one data structure stored in memory is to be shared among multiple concurrently running application processes managed by an application engine, identify, within the application engine, contextual information specifying various details regarding different functions that are operating among the concurrently running application processes, determine which data structures are currently shareable between a first application process and at least a second application process based on the identified contextual information within the application engine, and share the data structures of the first application process to at least the second application process.

In some examples, the above-described method is encoded as computer-readable instructions on a computer-readable medium. For example, the computer-readable medium may include one or more computer-executable instructions that, when executed by at least one processor of a computing device, cause the computing device to determine that at least one data structure stored in memory is to be shared among multiple concurrently running application processes managed by an application engine, identify, within the application engine, contextual information specifying various details regarding different functions that are operating among the concurrently running application processes, determine which data structures are currently shareable between a first application process and at least a second application process based on the identified contextual information within the application engine, and share the data structures of the first application process to at least the second application process.

Features from any of the embodiments described herein may be used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 illustrates a computing environment in which the embodiments herein are designed to operate.

FIG. 2 is a flow diagram of an exemplary method for sharing memory among multiple application instances.

FIG. 3 illustrates an alternative computing environment in which the embodiments herein are designed to operate.

FIG. 4 illustrates an embodiment in which data structure flags and hash identifiers are implemented to identify shareable information.

FIG. 5 illustrates an embodiment in which different application instances share a pool of content in a shared memory.

FIG. 6 is a block diagram of an exemplary content distribution ecosystem.

FIG. 7 is a block diagram of an exemplary distribution infrastructure within the content distribution ecosystem shown in FIG. 6.

FIG. 8 is a block diagram of an exemplary content player within the content distribution ecosystem shown in FIG. 6.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

The present disclosure is generally directed to methods and systems for sharing video memory (e.g., VRAM or graphics processing unit (GPU) memory) among multiple application instances including, specifically, among video game instances. As noted above, video games are often hosted remotely on cloud computing systems. These cloud computing systems are capable of running many thousands or millions of concurrent video gaming instances. In some cases, each of these application instances runs separately and uses its own collection of resources or content. In other cases, these application instances use resources that may be identical to the resources used by another video game instance.

For example, if multiple video game instances are running concurrently, at least some of those video game instances will likely use at least some of the same textures, the same shaders, the same vertices, the same buffers, or other similar types of content. This type of content has the potential to be shared among the various application instances. Moreover, within a video game engine, many additional data structures may be shared because of contextual information around the data structures. For example, within a video game engine, many similar types of data may be used, or certain data may be used at specific times, or may be used in context with other known data structures. Thus, by knowing many different contextual details about certain data structures, the systems herein can determine what the data structures are, what their purpose is, and whether they are shareable among other video game instances that are concurrently running.

As noted above, however, each physical GPU device typically has its own processor (or set of processing cores) and its own allocation of video random-access memory (VRAM). This VRAM operates very quickly and with very high throughput. VRAM is expensive, however, and, as a result, the GPU device will typically have less VRAM than a general processing computer would have with its corresponding traditional RAM. When running multiple game instances on a single GPU, VRAM thus becomes a contested resource and a primary bottleneck as the number of concurrent video game sessions increases.

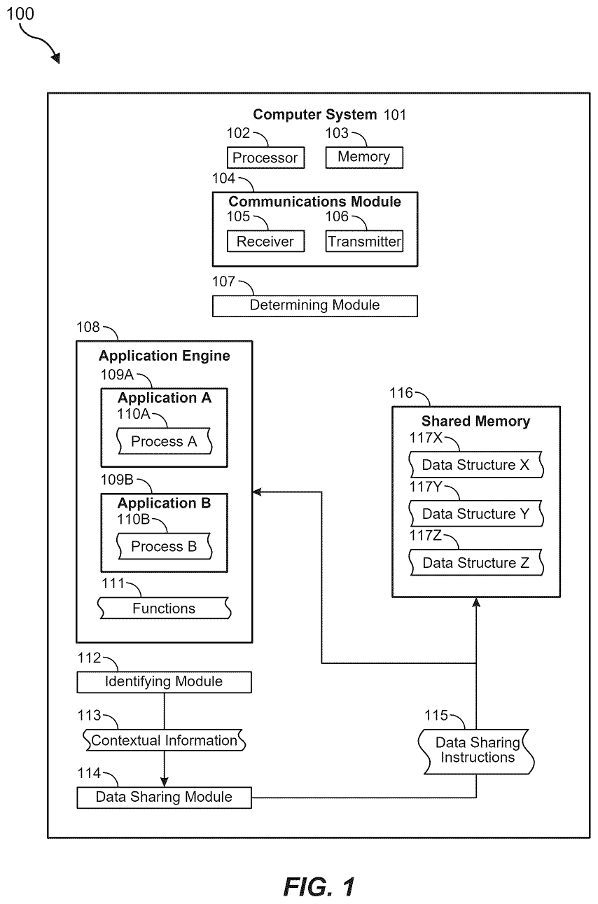

To help free up more VRAM for use by other video game instances, the embodiments herein aim to share the data structures that are temporarily stored in VRAM. When running similar or identical copies of a particular video game (or other application), the systems herein significantly reduce VRAM requirements by identifying contextual information related to a particular data structure. The contextual information may identify the size of the data structure, the data type, the data format, the source or destination of the data structure, etc. to identify what the data structure is. Once the system knows what the data structure is (e.g., a texture or a vertex, etc.), the system can flag the data structure as being shareable and then promulgate the flag to other video game instances, so they know to use the previously generated (shareable) data structure instead of creating and storing their own version of it. These embodiments will be described in greater detail below with regard to FIGS. 1-8.

FIG. 1 illustrates a computing environment 100 that includes a computer system 101. The computer system 101 includes software modules, embedded hardware components such as processors, or includes a combination of hardware and software. The computer system 101 includes substantially any type of computing system including a local computing system or a distributed (e.g., cloud) computing system. In some cases, the computer system 101 includes at least one processor 102 and at least some system memory 103. The computer system 101 includes program modules for performing a variety of different functions. The program modules are hardware-based, software-based, or include a combination of hardware and software. Each program module uses computing hardware and/or software to perform specified functions, including those described herein below.

The computer system 101 includes a communications module 104 that is configured to communicate with other computer systems. The communications module 104 includes any wired or wireless communication means that can receive and/or transmit data to or from other computer systems. These communication means include hardware interfaces including Ethernet adapters, WIFI adapters, hardware radios including, for example, a hardware-based receiver 105, a hardware-based transmitter 106, or a combined hardware-based transceiver capable of both receiving and transmitting data. The radios are cellular radios, Bluetooth radios, global positioning system (GPS) radios, or other types of radios. The communications module 104 is configured to interact with databases, mobile computing devices (such as mobile phones or tablets), embedded or other types of computing systems.

The computer system 101 also includes a determining module 107. The determining module 107 is configured to determine that a data structure is to be shared in memory. The data structure may have already been generated and is currently stored in memory (e.g., VRAM or GPU memory) or is in the pipeline for creation. As the term is used here, “data structure” may refer to any piece of data, including a file or portion of a file, a data blob, an immutable portion of data, a mutable portion of data, or other type of data. The data structure that is to be shared may be substantially any type of data, any size of data, or any data format. The data structure may include a single file or single file type or may include multiple files and/or multiple different file types.

The computer system 101 also includes an application engine 108. At least in some cases, the computer system 101 may have multiple application engine instances. Each application engine instance, in turn, is configured to run a corresponding application (e.g., application A (109A), application B (109B), or other applications). These may be separate applications or different instances of the same application (e.g., different instances of the same video game). The application engine 108 processes incoming commands and interfaces with GPU hardware, memory, or other computing hardware. At least in some cases, each of these applications 109A/109B is running different processes 110A/110B and/or different functions 111. These processes and functions carry out the purpose of the application. In the case of video games, the application engine 108 is a video game engine that renders graphics frames, processes gaming inputs, receives and transmits information over a network (e.g., via communications module 104), and performs other functions, including generating data structures and storing those data structures in memory.

In some embodiments, for instance, the application engine 108 stores data structures X, Y, and Z (e.g., 117X, 117Y, and 117Z) in shared memory 116. The shared memory 116 includes shared VRAM, shared GPU memory, shared RAM, or other type of memory. The shared memory 116 is accessible by each of the application processes 110A/110B running on the applications 109A/109B in the application engine. As such, the application processes write to and read from the shared memory 116 on a repeated and more or less constant basis. In cases where data has already been generated for one application, that data can be reused by other applications if their processes know about the stored data and where to find it.

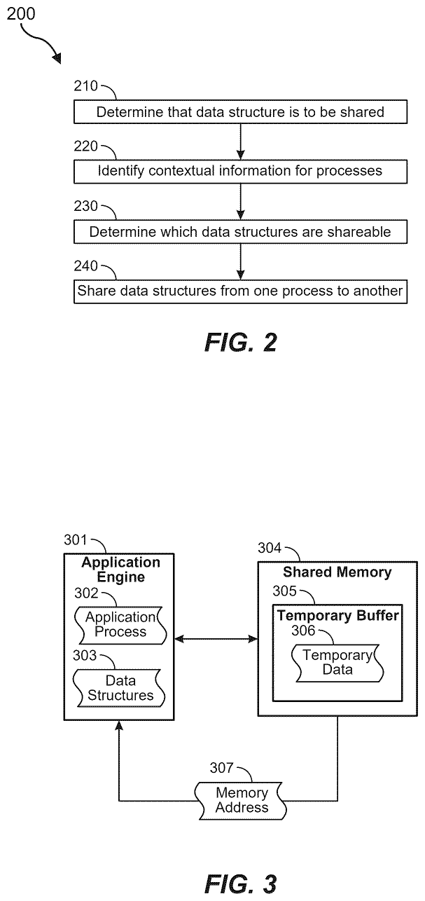

The embodiments described herein implement the identifying module 112 to identify contextual information 113 related to the data structures stored in the shared memory 116. The identifying module 112 may look for context around a particular data structure, including which process generated the data, which process will use the data, where the data is being sent, what type of data, what size of data, etc. Each of these contextual clues from within the application engine 108 is used to determine what the data structure is and whether it is shareable. Upon determining that the data structure is shareable, the data sharing module 114 instructs the applications and/or the shared memory to share the identified data structures via data sharing instructions 115. These embodiments will be explained further below with regard to method 200 of FIG. 2.

FIG. 2 is a flow diagram of an exemplary computer-implemented method 200 for sharing video memory. The steps shown in FIG. 2 may be performed by any suitable computer-executable code and/or computing system, including the system illustrated in FIG. 1. In one example, each of the steps shown in FIG. 2 may represent an algorithm whose structure includes and/or is represented by multiple sub-steps, examples of which will be provided in greater detail below.

As illustrated in FIG. 2, at step 210, method 200 includes determining that at least one data structure stored in memory is to be shared among multiple concurrently running application processes managed by an application engine. At step 220, the method includes identifying, within the application engine, contextual information specifying various details regarding different functions that are operating among the concurrently running application processes. At step 230, the method includes determining which data structures are currently shareable between a first application process and at least a second application process based on the identified contextual information within the application engine. At step 240, the method includes sharing the data structures of the first application process to the second application process. This method 200 will be explored further with regard to FIGS. 3-6 and with continued reference to FIG. 1.

FIG. 3 illustrates an embodiment in which an application engine 301 interfaces with a temporary buffer 305 on a shared memory 304 to access some portion of temporary data. In some systems, immutable data objects are shared between application processes 302. In the embodiments described herein, both immutable and mutable data structures may be shared among application processes 302. Indeed, in the embodiments herein, temporary (mutable) data 306 that is stored in a temporary buffer 305 is shareable because of the contextual information that is available within the application engine 301.

As noted above, the application engine 301 generates data, routes data, stores data, and generally manages the transfer of data between processors, memory, bridges, network interfaces, and other components. Because the application engine 301 knows which processes are creating which data structures 303, where those data structures are used, how those data structures are used, etc., the application engine either knows or can reasonably estimate how long each data structure will be stored in the shared memory 304 and, thus, how long the data structure will be accessible by other application processes.

By sharing data structures and other resources between instances of an application (e.g., a video game) running on the same computing platform (or the same server or same CPU and/or GPU)), the embodiments herein reduce the amount of VRAM used by the application or video game. This allows the system to either improve the graphical quality of a video gaming instance and/or increase the number of application instances that can be run on a given server or computing platform.

In some cases, the embodiments herein create a server or platform process that is designed to handle resource sharing requests from different applications and different application instances. The underlying process includes an application programming interface (API) that is configured to request memory for a shareable resource (e.g., a shareable data structure). The resource sharing API accesses an identifier (e.g., memory address 307) from the application or video game to identify the resource. The resource sharing API then activates the shared resource and indicates that the resource is ready to be used. At least in some cases, the API only needs to be called the first time a resource is exposed for sharing. If a resource has been activated by another instance while being activated, then the application or game will remap its current resource to the previously allocated memory. The API also releases memory for shared resources.

At least in some cases, the embodiments herein operate without modifying the application engine 301. In other cases, the embodiments herein will modify or make changes to the application engine 301. Many different video game or other application engines may be modified to work with resource sharing, as described herein. For instance, in some cases, the engines are modified to use the shareable resource API. The video games themselves do not need to be modified, thereby avoiding the complexities that would come from having to change each game to allow resource sharing. Rather, the application engine 301 may be modified by adding hooks into various places in the engine from which the systems herein can call specific code which, at least in some embodiments, will live in a separate module or plugin. The systems herein will then perform any necessary steps and/or call the resource sharing API.

In one example, the application engine 301 will allocate GPU memory (or VRAM or other shared memory 304) when creating resources. If the system identifies a resource as being shareable, then the system will instead call the shareable resource API and retrieve the data structure from the shared memory 304. Additionally, at least in some cases, the systems herein will prevent the application engine 301 from uploading data (such as mipmaps) to the GPU, as the shared data is already initialized. Immutable textures or other data structures can generally be recognized by looking for images that do not have usage flags, such as color attachments, depth/stencil attachments, or storage. Such textures would neither be render targets nor compute targets. Application engines may have a pool of render targets, but they may allocate the render targets for the lifetime of the level (or application stage) even if the render targets are not used all of the time.

In some embodiments, the systems herein explicitly return the render targets to a shared pool when not in use. This shared pool would then be managed by the shareable resource API. At least in some cases, this would be a single pool shared amongst instances. This could mean that, for example, while 100 render targets might be needed for all the various instances with separate pools, using the shared pool, only 80 (or fewer) might be needed (e.g., a 20% reduction). Additional memory savings come from the fact that render targets are returned to the shared pool more often. Moreover, the varying load between instances can be shared in the shared pool. With separate pools, systems have an overhead per pool to accommodate varying loads. With a single pool, systems can benefit from a smaller overhead, as the overhead can be shared amongst all the instances.

Render targets that are updated every frame may be shareable with the shareable resource API if they act like temporary buffers (e.g., 305). That is, the render target's life is temporary and does not extend to the entirety of an application or video game session. In other words, the system may be unconcerned about the contents of the temporary buffer 305 at the start of some amount of finite time and may be further unconcerned about what happens to the buffer after that time. This type of sharing would also work for immutable textures. For example, if video game instance #1 has a resource R1, and video game instance #2 has a resource R2, R1 and R2 would actually point to the same memory location. The reason why it is possible to share mutable render targets is that the operations performed by instances #1 and #2 do not overlap, and they do not care about what happens to the contents before or after they use the render target.

One example of such a render target is a depth buffer. Video game instance #1 renders its game using the depth buffer, and then instance #2 renders its game using the same depth buffer. When instance #1 renders the next frame, the fact that instance #2 used the same buffer is inconsequential, as the buffer will be cleared again before use. Note that unlike immutable resources like textures, render targets could be shared between different games or different game instances. Only the render target specification needs to match for the resource to be shareable; the contents of the render target do not matter. At least in some cases, the systems herein may clear the render targets outside of the application to fully control the data, although this may incur a performance penalty, leading to a potential tradeoff between the VRAM savings and the performance penalty when deciding if this should be done. Within the application engine 301, render targets may have no unique name. As such, the embodiments herein are designed to generate identifiers for the render targets by looking at their surrounding contextual information.

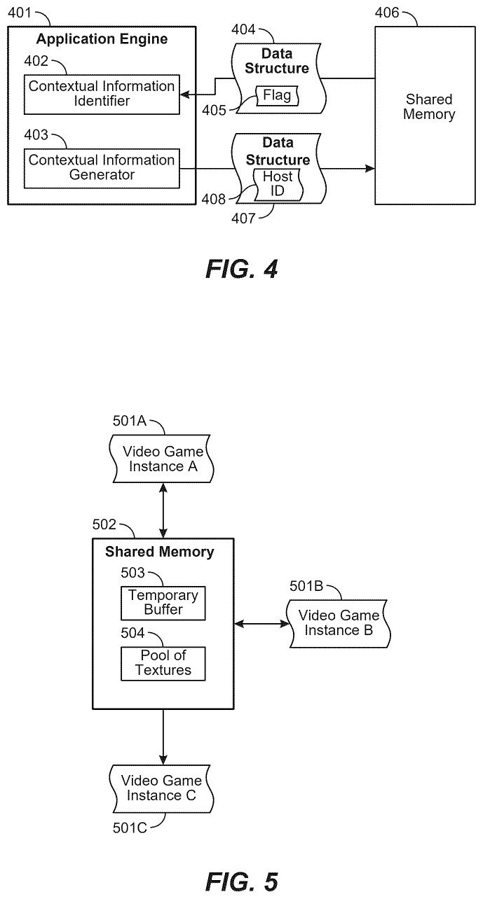

In some cases, as shown in FIG. 4, an application engine may be configured to look for existing flags in data structures (e.g., flag 405 in data structure 404) or may be configured to create flags or other identifiers in data structures. As noted above, application engines have a great deal of knowledge about which data structures are created, transferred, used, and stored within the system. Moreover, even if knowledge about a given data structure is incomplete, the application engine 401 can still determine or piece together, based on contextual information, how the data structure 404 will be used, which application process created that data structure, what its size and format is, etc.

Indeed, the contextual information identifier 402 can identify multiple different details regarding various functions that are operating among a plurality of concurrently running application processes. This contextual information includes size of data, name of data, type of data, where data is stored in memory, which buffer the data was created for, which data file the data is part of, an indication of how the data is used within the application engine 401, or other indications of context. This context is then used to determine whether data structures stored in the shared memory 406 are shareable among the concurrently running application instances.

In some cases, the contextual information identifier 402 identifies flags or other cues that are embedded in the data structure 404 or are associated with the data structure (e.g., metadata). In other cases, the contextual information generator 403 looks at the available contextual information for a given data structure and generates information for that data structure. The data structure 407 may include a resource identifier or a unique hash identifier 408 that specifically identifies that data structure (e.g., a texture). Because the flag indicates that the data structure is shareable and because the hash identifier 408 uniquely identifies the data structure, other application instances can identify and access that data structure as it sits in shared memory 406.

Those application instances that access the previously generated data structure in shared memory 406 can avoid taking the GPU and/or CPU time to generate that data structure and, instead, can use those processing resources for other games or for improving a currently running video game or other process. Thus, in cases where the application engine 401 is a video game engine, the shared data structures are shared between a first instance of a video game and a second instance of the same video game that are running concurrently, using flags 405/407 generated by or identified by the video game engine. In still other cases, the shared data structures are shared between a first instance of the video game and multiple additional instances of the video game that are running concurrently.

In some embodiments, as shown in FIG. 5, the shared data structures are temporary data stored in a temporary buffer 503 used by the application engine. For instance, in some cases, a pool of textures 504 that have been previously generated is stored in a shared memory 502. The pool of textures may be stored in the temporary buffer 503 or in the shared memory 502 in general. Other shareable data may include vertices for generating 3D elements, shaders, or other graphical elements. In some cases, the shareable data may include stream buffers for streaming video data that is streamed across multiple video game instances that are all showing a video at the same time. In other cases, audio data, video data, graphical data, video game map data, or other data structures stored in the shared memory 502 and/or the temporary buffer 503 are shareable among video game instance A (501A), among video game instance B (501B), among video game instance C (501C), and/or among other video game instances.

In some cases, sharing the data structures from one video game process to another video game process (or other application process) includes sharing a memory address (e.g., 307 of FIG. 3) identifying where the shared data structure is stored. The memory address may indicate, for example, which temporary buffer 503 is storing the shareable data structure. In some cases, determining which data structures are currently shareable between one application process and another application process includes identifying hash identifiers, resource identifiers, or other processing flags within the application engine.

In some cases, the identifiers are automatically applied to the data structures by the application engine, while in other cases, the application engine is modified to generate the hash identifiers, resource identifiers, or other processing flags. These identifiers and flags are then used to determine which data structures are shareable and how those data structures can be used (or reused) by other application processes. At least in some cases, this data sharing occurs in real-time as data structures are generated and loaded into and out of shared memory 502 (e.g., VRAM).

In some embodiments, the application engine (e.g., 401 of FIG. 4) works with drivers for processing, storage, and/or networking hardware. The drivers allow applications to interface with the hardware and control the hardware to perform processing, storage, networking, or other tasks. In some cases, the underlying system (e.g., computer system 101 of FIG. 1) communicates directly with the application engine to instruct drivers associated with the application engine to hold on to a specific shared data structure for at least a certain amount of time. For instance, the application engine 401 or the computer system 101 or data sharing module 114 may instruct a storage driver to retain a specific data structure in shared memory 406 for 10 ms or 50 ms or 100 ms or some other time (e.g., via data sharing instructions 115). This allows other application processes to access that specific data structure for the extended amount of time. After the specified amount of time expires, the data structure can be expunged from the shared memory 406.

During that specified amount of time in which the shared memory is to retain the specified data structure and/or prevent other application processes from removing the data structure from shared memory, the shared data structure is protected from alterations or corrections by other processing hardware. In such cases, the shared data structure is protected from alterations or changes by a CPU, by a GPU, or by another processing component for at least a specified amount of time.

Thus, for example, if a shared data structure (e.g., vertex data that expresses three-dimensional shapes for various stored textures) is to be retained in shared memory for 25 ms, that vertex data will be retained in the shared memory for at least 25 ms and will be protected from being overwritten or changed by CPUs or GPUs. In this manner, data may be retained in shared memory for a customizable amount of time that is specific to the data structure being retained (or is specific to the type of data being retained). As such, programmers implementing the (modified) application engine 401 can specify that certain data structures or certain types of data (e.g., vertex data) are to be stored longer than normal and for at least a specified additional amount of time. This allows other applications extra time to use the already-created, shared data structure before it is unloaded from memory.

In addition to the computer-implemented method described above, a corresponding system is also described. The system includes at least one physical processor, and physical memory comprising computer-executable instructions that, when executed by the physical processor, cause the physical processor to: determine that at least one data structure stored in memory is to be shared among multiple concurrently running application processes managed by an application engine, identify, within the application engine, contextual information specifying various details regarding different functions that are operating among the concurrently running application processes, determine which data structures are currently shareable between a first application process and at least a second application process based on the identified contextual information within the application engine, and share the data structures of the first application process to at least the second application process.

Still further, a non-transitory computer-readable medium is provided that includes one or more computer-executable instructions that, when executed by at least one processor of a computing device, cause the computing device to: determine that at least one data structure stored in memory is to be shared among multiple concurrently running application processes managed by an application engine, identify, within the application engine, contextual information specifying various details regarding different functions that are operating among the concurrently running application processes, determine which data structures are currently shareable between a first application process and at least a second application process based on the identified contextual information within the application engine, and share the data structures of the first application process to at least the second application process.

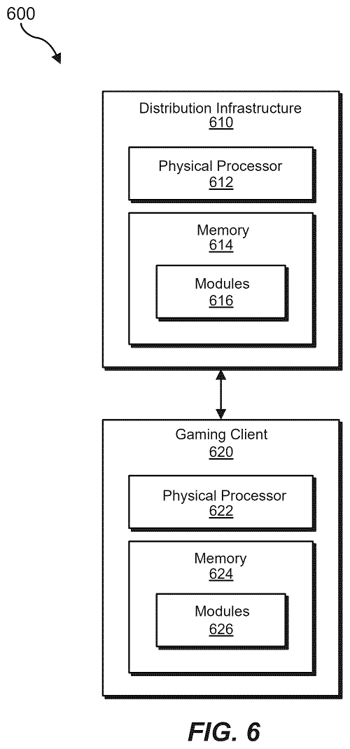

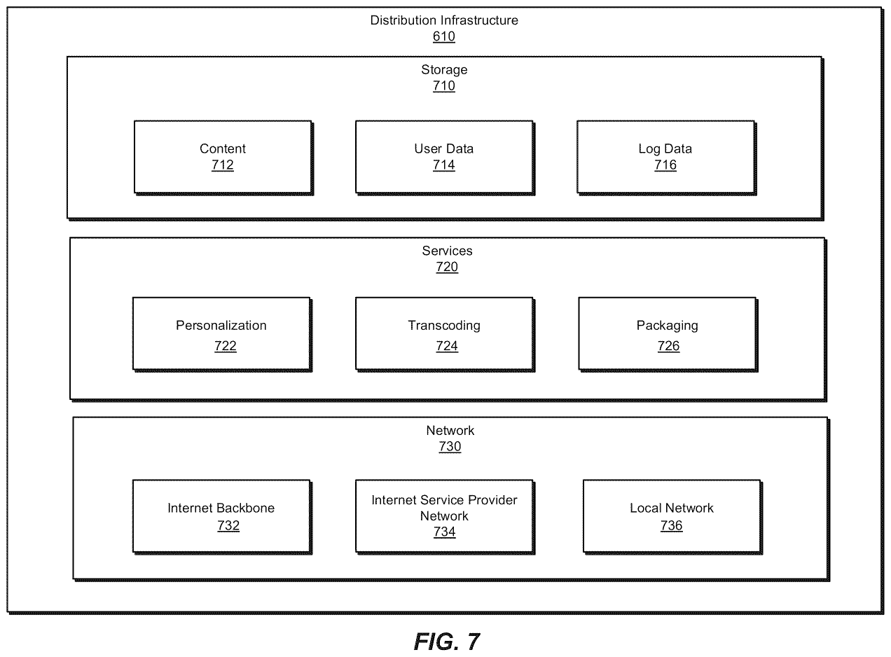

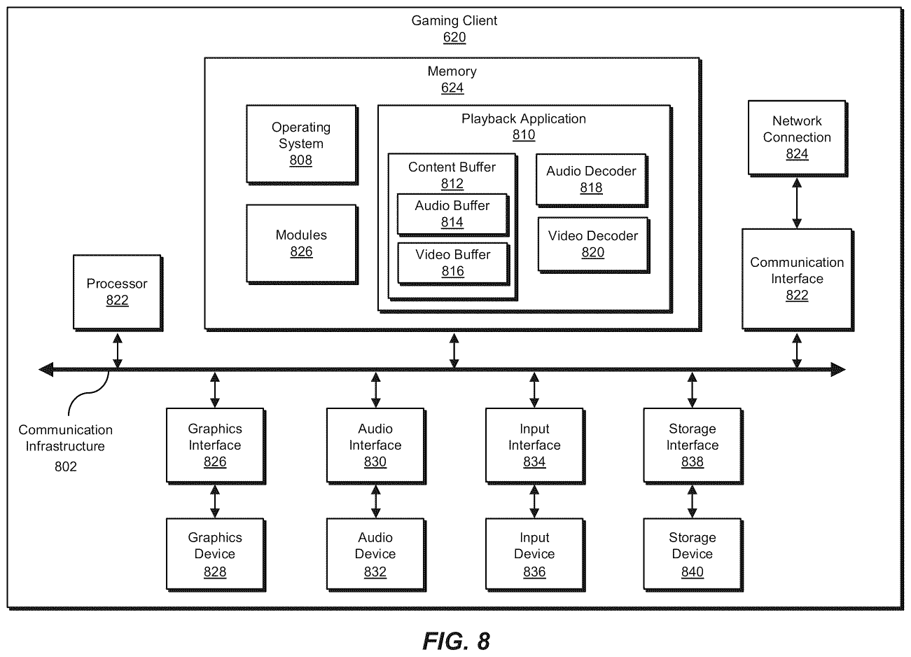

FIGS. 6-8 illustrate cloud gaming systems, infrastructure, and clients that may be implemented with the embodiments herein. For example, the following will provide, with reference to FIG. 6, detailed descriptions of exemplary ecosystems in which content is provisioned to end nodes and in which requests for content are steered to specific end nodes. The discussion corresponding to FIGS. 7 and 8 presents an overview of an exemplary distribution infrastructure and an exemplary content player used during playback sessions, respectively.

FIG. 6 is a block diagram of a content distribution ecosystem 600 that includes a distribution infrastructure 610 in communication with a gaming client 620, content player, or other software application designed to present rendered graphics to a user. In some embodiments, distribution infrastructure 610 is configured to encode data at a specific data rate and to transfer the encoded data to gaming client 620. Gaming client 620 is configured to receive the encoded data via distribution infrastructure 610 and to decode the data for playback to a user. The data provided by distribution infrastructure 610 includes, for example, audio, video, text, images, animations, interactive content, haptic data, virtual or augmented reality data, location data, gaming data, or any other type of data that is provided via streaming.

Distribution infrastructure 610 generally represents any services, hardware, software, or other infrastructure components configured to deliver content to end users. For example, distribution infrastructure 610 includes content aggregation systems, media transcoding and packaging services, network components, and/or a variety of other types of hardware and software. In some cases, distribution infrastructure 610 is implemented as a highly complex distribution system, a single media server or device, or anything in between. In some examples, regardless of size or complexity, distribution infrastructure 610 includes at least one physical processor 612 and at least one memory device 614. One or more modules 616 are stored or loaded into memory 614 to enable adaptive streaming, as discussed herein.

Gaming client 620 generally represents any type or form of device or system capable of playing audio, video, or other gaming content that has been provided over distribution infrastructure 610. Examples of gaming client 620 include, without limitation, mobile phones, tablets, laptop computers, desktop computers, televisions, set-top boxes, digital media players, virtual reality headsets, augmented reality glasses, and/or any other type or form of device capable of rendering digital content. As with distribution infrastructure 610, gaming client 620 includes a physical processor 622, memory 624, and one or more modules 626. Some or all of the adaptive streaming processes described herein is performed or enabled by modules 626, and in some examples, modules 616 of distribution infrastructure 610 coordinate with modules 626 of gaming client 620 to provide adaptive streaming of multimedia content.

In certain embodiments, one or more of modules 616 and/or 626 in FIG. 6 represent one or more software applications or programs that, when executed by a computing device, cause the computing device to perform one or more tasks. For example, and as will be described in greater detail below, one or more of modules 616 and 626 represent modules stored and configured to run on one or more general-purpose computing devices. One or more of modules 616 and 626 in FIG. 6 also represent all or portions of one or more special-purpose computers configured to perform one or more tasks.

In addition, one or more of the modules, processes, algorithms, or steps described herein transform data, physical devices, and/or representations of physical devices from one form to another. For example, one or more of the modules recited herein receive audio data to be encoded, transform the audio data by encoding it, output a result of the encoding for use in an adaptive audio bit-rate system, transmit the result of the transformation to a content player, and render the transformed data to an end user for consumption. Additionally or alternatively, one or more of the modules recited herein transform a processor, volatile memory, non-volatile memory, and/or any other portion of a physical computing device from one form to another by executing on the computing device, storing data on the computing device, and/or otherwise interacting with the computing device.

Physical processors 612 and 622 generally represent any type or form of hardware-implemented processing unit capable of interpreting and/or executing computer-readable instructions. In one example, physical processors 612 and 622 access and/or modify one or more of modules 616 and 626, respectively. Additionally or alternatively, physical processors 612 and 622 execute one or more of modules 616 and 626 to facilitate adaptive streaming of multimedia content. Examples of physical processors 612 and 622 include, without limitation, microprocessors, microcontrollers, central processing units (CPUs), field-programmable gate arrays (FPGAs) that implement softcore processors, application-specific integrated circuits (ASICs), portions of one or more of the same, variations or combinations of one or more of the same, and/or any other suitable physical processor.

Memory 614 and 624 generally represent any type or form of volatile or non-volatile storage device or medium capable of storing data and/or computer-readable instructions. In one example, memory 614 and/or 624 stores, loads, and/or maintains one or more of modules 616 and 626. Examples of memory 614 and/or 624 include, without limitation, random access memory (RAM), read only memory (ROM), flash memory, hard disk drives (HDDs), solid-state drives (SSDs), optical disk drives, caches, variations or combinations of one or more of the same, and/or any other suitable memory device or system.

FIG. 7 is a block diagram of exemplary components of content distribution infrastructure 610 according to certain embodiments. Distribution infrastructure 610 includes storage 710, services 720, and a network 730. Storage 710 generally represents any device, set of devices, and/or systems capable of storing content for delivery to end users. Storage 710 includes a central repository with devices capable of storing terabytes or petabytes of data and/or includes distributed storage systems (e.g., appliances that mirror or cache content at Internet interconnect locations to provide faster access to the mirrored content within certain regions). Storage 710 is also configured in any other suitable manner.

As shown, storage 710 may store a variety of different items including content 712, user data 714, and/or log data 716. Content 712 includes television shows, movies, video games, user-generated content, and/or any other suitable type or form of content. User data 714 includes personally identifiable information (PII), payment information, preference settings, language and accessibility settings, and/or any other information associated with a particular user or content player. Log data 716 includes viewing history information, network throughput information, and/or any other metrics associated with a user's connection to or interactions with distribution infrastructure 610.

Services 720 includes personalization services 722, transcoding services 724, and/or packaging services 726. Personalization services 722 personalize recommendations, content streams, and/or other aspects of a user's experience with distribution infrastructure 610. Encoding services 724 compress media at different bitrates which, as described in greater detail below, enable real-time switching between different encodings. Packaging services 726 package encoded video before deploying it to a delivery network, such as network 730, for streaming.

Network 730 generally represents any medium or architecture capable of facilitating communication or data transfer. Network 730 facilitates communication or data transfer using wireless and/or wired connections. Examples of network 730 include, without limitation, an intranet, a wide area network (WAN), a local area network (LAN), a personal area network (PAN), the Internet, power line communications (PLC), a cellular network (e.g., a global system for mobile communications (GSM) network), portions of one or more of the same, variations or combinations of one or more of the same, and/or any other suitable network. For example, as shown in FIG. 7, network 730 includes an Internet backbone 732, an internet service provider 734, and/or a local network 736. As discussed in greater detail below, bandwidth limitations and bottlenecks within one or more of these network segments triggers video and/or audio bit rate adjustments.

FIG. 8 is a block diagram of an exemplary implementation of gaming client 620 of FIG. 6. Gaming client 620 generally represents any type or form of computing device capable of reading computer-executable instructions. Gaming client 620 includes, without limitation, laptops, tablets, desktops, servers, cellular phones, multimedia players, embedded systems, wearable devices (e.g., smart watches, smart glasses, etc.), smart vehicles, gaming consoles, internet-of-things (IoT) devices such as smart appliances, variations or combinations of one or more of the same, and/or any other suitable computing device.

As shown in FIG. 8, in addition to processor 622 and memory 624, gaming client 620 includes a communication infrastructure 802 and a communication interface 822 coupled to a network connection 824. Gaming client 620 also includes a graphics interface 826 coupled to a graphics device 828, an input interface 834 coupled to an input device 836, and a storage interface 838 coupled to a storage device 840.

Communication infrastructure 802 generally represents any type or form of infrastructure capable of facilitating communication between one or more components of a computing device. Examples of communication infrastructure 802 include, without limitation, any type or form of communication bus (e.g., a peripheral component interconnect (PCI) bus, PCI Express (PCIe) bus, a memory bus, a frontside bus, an integrated drive electronics (IDE) bus, a control or register bus, a host bus, etc.).

As noted, memory 624 generally represents any type or form of volatile or non-volatile storage device or medium capable of storing data and/or other computer-readable instructions. In some examples, memory 624 stores and/or loads an operating system 808 for execution by processor 622. In one example, operating system 808 includes and/or represents software that manages computer hardware and software resources and/or provides common services to computer programs and/or applications on gaming client 620.

Operating system 808 performs various system management functions, such as managing hardware components (e.g., graphics interface 826, audio interface 830, input interface 834, and/or storage interface 838). Operating system 808 also provides process and memory management models for playback application 810. The modules of playback application 810 includes, for example, a content buffer 812, an audio decoder 818, and a video decoder 820.

Playback application 810 is configured to retrieve digital content via communication interface 822 and to play the digital content through graphics interface 826. Graphics interface 826 is configured to transmit a rendered video signal to graphics device 828. In normal operation, playback application 810 receives a request from a user to play a specific title or specific content. Playback application 810 then identifies one or more encoded video and audio streams associated with the requested title. After playback application 810 has located the encoded streams associated with the requested title, playback application 810 downloads sequence header indices associated with each encoded stream associated with the requested title from distribution infrastructure 610. A sequence header index associated with encoded content includes information related to the encoded sequence of data included in the encoded content.

In one embodiment, playback application 810 begins downloading the content associated with the requested title by downloading sequence data encoded to the lowest audio and/or video playback bitrates to minimize startup time for playback. The requested digital content file is then downloaded into content buffer 812, which is configured to serve as a first-in, first-out queue. In one embodiment, each unit of downloaded data includes a unit of video data or a unit of audio data. As units of video data associated with the requested digital content file are downloaded to the gaming client 620, the units of video data are pushed into the content buffer 812. Similarly, as units of audio data associated with the requested digital content file are downloaded to the gaming client 620, the units of audio data are pushed into the content buffer 812. In one embodiment, the units of video data are stored in video buffer 816 within content buffer 812 and the units of audio data are stored in audio buffer 814 of content buffer 812.

A video decoder 820 reads units of video data from video buffer 816 and outputs the units of video data in a sequence of video frames corresponding in duration to the fixed span of playback time. Reading a unit of video data from video buffer 816 effectively de-queues the unit of video data from video buffer 816. The sequence of video frames is then rendered by graphics interface 826 and transmitted to graphics device 828 to be displayed to a user.

An audio decoder 818 reads units of audio data from audio buffer 814 and output the units of audio data as a sequence of audio samples, generally synchronized in time with a sequence of decoded video frames. In one embodiment, the sequence of audio samples is transmitted to audio interface 830, which converts the sequence of audio samples into an electrical audio signal. The electrical audio signal is then transmitted to a speaker of audio device 832, which, in response, generates an acoustic output.

In situations where the bandwidth of distribution infrastructure 610 is limited and/or variable, playback application 810 downloads and buffers consecutive portions of video data and/or audio data from video encodings with different bit rates based on a variety of factors (e.g., scene complexity, audio complexity, network bandwidth, device capabilities, etc.). In some embodiments, video playback quality is prioritized over audio playback quality. Audio playback and video playback quality are also balanced with each other, and in some embodiments audio playback quality is prioritized over video playback quality.

Graphics interface 826 is configured to generate frames of video data and transmit the frames of video data to graphics device 828. In one embodiment, graphics interface 826 is included as part of an integrated circuit, along with processor 622. Alternatively, graphics interface 826 is configured as a hardware accelerator that is distinct from (i.e., is not integrated within) a chipset that includes processor 622.

Graphics interface 826 generally represents any type or form of device configured to forward images for display on graphics device 828. For example, graphics device 828 is fabricated using liquid crystal display (LCD) technology, cathode-ray technology, and light-emitting diode (LED) display technology (either organic or inorganic). In some embodiments, graphics device 828 also includes a virtual reality display and/or an augmented reality display. Graphics device 828 includes any technically feasible means for generating an image for display. In other words, graphics device 828 generally represents any type or form of device capable of visually displaying information forwarded by graphics interface 826.

As illustrated in FIG. 8, gaming client 620 also includes at least one input device 836 coupled to communication infrastructure 802 via input interface 834. Input device 836 generally represents any type or form of computing device capable of providing input, either computer or human generated, to gaming client 620. Examples of input device 836 include, without limitation, a keyboard, a pointing device, a speech recognition device, a touch screen, a wearable device (e.g., a glove, a watch, etc.), a controller, variations or combinations of one or more of the same, and/or any other type or form of electronic input mechanism.

Gaming client 620 also includes a storage device 840 coupled to communication infrastructure 802 via a storage interface 838. Storage device 840 generally represents any type or form of storage device or medium capable of storing data and/or other computer-readable instructions. For example, storage device 840 may be a magnetic disk drive, a solid-state drive, an optical disk drive, a flash drive, or the like. Storage interface 838 generally represents any type or form of interface or device for transferring data between storage device 840 and other components of gaming client 620.

Many other devices or subsystems are included in or connected to gaming client 620. Conversely, one or more of the components and devices illustrated in FIG. 8 need not be present to practice the embodiments described and/or illustrated herein. The devices and subsystems referenced above are also interconnected in different ways from that shown in FIG. 8. Gaming client 620 is also employed in any number of software, firmware, and/or hardware configurations. For example, one or more of the example embodiments disclosed herein are encoded as a computer program (also referred to as computer software, software applications, computer-readable instructions, or computer control logic) on a computer-readable medium. The term “computer-readable medium,” as used herein, refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, etc.), optical-storage media (e.g., Compact Disks (CDs), Digital Video Disks (DVDs), and BLU-RAY disks), electronic-storage media (e.g., solid-state drives and flash media), and other digital storage systems.

A computer-readable medium containing a computer program is loaded into gaming client 620. All or a portion of the computer program stored on the computer-readable medium is then stored in memory 624 and/or storage device 840. When executed by processor 622, a computer program loaded into memory 624 causes processor 622 to perform and/or be a means for performing the functions of one or more of the example embodiments described and/or illustrated herein. Additionally or alternatively, one or more of the example embodiments described and/or illustrated herein are implemented in firmware and/or hardware. For example, gaming client 620 is configured as an Application Specific Integrated Circuit (ASIC) adapted to implement one or more of the example embodiments disclosed herein.

### EXAMPLE EMBODIMENTS

Example 1: A computer-implemented method comprising: determining that at least one data structure stored in memory is to be shared among a plurality of concurrently running application processes managed by an application engine, identifying, within the application engine, contextual information specifying one or more details regarding different functions that are operating among the plurality of concurrently running application processes, determining which data structures are currently shareable between a first application process and at least a second application process based on the identified contextual information within the application engine, and sharing the data structures of the first application process to at least the second application process.

Example 2: The computer-implemented method of Example 1, wherein the shared data structures comprise temporary data stored in a temporary buffer used by the application engine.

Example 3: The computer-implemented method of Example 1 or Example 2, wherein sharing the data structures from the first application process to the second application process includes sharing a memory address identifying where the shared data structure is stored.

Example 4: The computer-implemented method of any of Examples 1-3, wherein determining which data structures are currently shareable between the first application process and the second application process comprises identifying processing flags within the application engine.

Example 5: The computer-implemented method of any of Examples 1-4, further comprising instructing the application engine to create flags for data structures that are shareable between application processes.

Example 6: The computer-implemented method of any of Examples 1-5, wherein at least one of the flags for the data structures comprises a resource identifier or a unique hash identifier.

Example 7: The computer-implemented method of any of Examples 1-6, wherein the application engine comprises a video game engine and wherein the application comprises a video game.

Example 8: The computer-implemented method of any of Examples 1-7, wherein the shared data structures are shared between a first instance of the video game and a second instance of the video game running concurrently.

Example 9: The computer-implemented method of any of Examples 1-8, wherein the shared data structures are shared between a first instance of the video game and a plurality of additional instances of the video game running concurrently.

Example 10: The computer-implemented method of any of Examples 1-9, wherein the contextual information specifying one or more details regarding different functions that are operating among the plurality of concurrently running application processes comprises at least one of: size of data, name of data, type of data, where data is stored in memory, which buffer the data was created for, which data file the data is part of, or an indication of how the data is used within the application engine.

Example 11: The computer-implemented method of any of Examples 1-10, further comprising instruct a driver associated with the application engine to hold on to the shared data structure for at least a specified amount of time before releasing the shared data structure.

Example 12: The computer-implemented method of any of Examples 1-11, wherein the shared data structure is protected from alterations or corrections from a CPU or GPU for at least a specified amount of time.

Example 13: A system comprising: at least one physical processor, and physical memory comprising computer-executable instructions that, when executed by the physical processor, cause the physical processor to: determine that at least one data structure stored in memory is to be shared among a plurality of concurrently running application processes managed by an application engine, identify, within the application engine, contextual information specifying one or more details regarding different functions that are operating among the plurality of concurrently running application processes, determine which data structures are currently shareable between a first application process and at least a second application process based on the identified contextual information within the application engine, and share the data structures of the first application process to at least the second application process.

Example 14: The system of Example 13, wherein the shared data structures comprise a stored pool of textures used by the application engine.

Example 15: The system of Example 13 or Example 14, wherein the shared data structures comprise vertex data that expresses one or more three-dimensional shapes for the stored textures.

Example 16: The system of any of Examples 13-15, wherein the shared data structures comprise stream buffers for shared video that is concurrently being played across two or more application instances.

Example 17: The system of any of Examples 13-16, wherein sharing the data structures of the first application process to at least the second application process occurs in real-time.

Example 18: The system of any of Examples 13-17, wherein the application engine comprises a video game engine and wherein the application comprises a video game.

Example 19: The system of any of Examples 13-18, wherein the shared data structures are shared between a first instance of the video game and a second instance of the video game running concurrently.

Example 20: A non-transitory computer-readable medium comprising one or more computer-executable instructions that, when executed by at least one processor of a computing device, cause the computing device to: determine that at least one data structure stored in memory is to be shared among a plurality of concurrently running application processes managed by an application engine, identify, within the application engine, contextual information specifying one or more details regarding different functions that are operating among the plurality of concurrently running application processes, determine which data structures are currently shareable between a first application process and at least a second application process based on the identified contextual information within the application engine, and share the data structures of the first application process to at least the second application process.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A computer-implemented method comprising:
determining that at least one data structure stored in memory is to be shared among a plurality of concurrently running application processes managed by an application engine;
identifying, within the application engine, contextual information specifying one or more details regarding different functions that are operating among the plurality of concurrently running application processes;
determining which data structures are currently shareable between a first application process and at least a second application process based on the identified contextual information within the application engine; and
sharing the data structures of the first application process to at least the second application process.

2. The computer-implemented method of claim 1, wherein the shared data structures comprise temporary data stored in a temporary buffer used by the application engine.

3. The computer-implemented method of claim 1, wherein sharing the data structures from the first application process to the second application process includes sharing a memory address identifying where the shared data structure is stored.

4. The computer-implemented method of claim 1, wherein determining which data structures are currently shareable between the first application process and the second application process comprises identifying processing flags within the application engine.

5. The computer-implemented method of claim 4, further comprising instructing the application engine to create flags for data structures that are shareable between application processes.

6. The computer-implemented method of claim 5, wherein at least one of the members of the data structures comprises a resource identifier or a unique hash identifier.

7. The computer-implemented method of claim 1, wherein the application engine comprises a video game engine and wherein the application comprises a video game.

8. The computer-implemented method of claim 7, wherein the shared data structures are shared between a first instance of the video game and a second instance of the video game running concurrently.

9. The computer-implemented method of claim 7, wherein the shared data structures are shared between a first instance of the video game and a plurality of additional instances of the video game running concurrently.

10. The computer-implemented method of claim 1, wherein the contextual information specifying one or more details regarding different functions that are operating among the plurality of concurrently running application processes comprises at least one of: size of data, name of data, type of data, where data is stored in memory, which buffer the data was created for, which data file the data is part of, or an indication of how the data is used within the application engine.

11. The computer-implemented method of claim 1, further comprising instructing a driver or module associated with the application engine to hold on to the shared data structure for at least a specified amount of time before releasing the shared data structure.

12. The computer-implemented method of claim 1, wherein the shared data structure is protected from alterations or corrections from a CPU or GPU for at least a specified amount of time.

13. A system comprising:
at least one physical processor; and
physical memory comprising computer-executable instructions that, when executed by the physical processor, cause the physical processor to:
determine that at least one data structure stored in memory is to be shared among a plurality of concurrently running application processes managed by an application engine;
identify, within the application engine, contextual information specifying one or more details regarding different functions that are operating among the plurality of concurrently running application processes;
determine which data structures are currently shareable between a first application process and at least a second application process based on the identified contextual information within the application engine; and
share the data structures of the first application process to at least the second application process.

14. The system of claim 13, wherein the shared data structures comprise a stored pool of textures used by the application engine.

15. The system of claim 14, wherein the shared data structures comprise vertex data that expresses one or more three-dimensional shapes for the stored textures.

16. The system of claim 13, wherein the shared data structures comprise stream buffers for shared video that is concurrently being played across two or more application instances.

17. The system of claim 13, wherein sharing the data structures of the first application process to at least the second application process occurs in real-time.

18. The system of claim 17, wherein the application engine comprises a video game engine and wherein the application comprises a video game.

19. The system of claim 18, wherein the shared data structures are shared between a first instance of the video game and a second instance of the video game running concurrently.

20. A non-transitory computer-readable medium comprising one or more computer-executable instructions that, when executed by at least one processor of a computing device, cause the computing device to:
determine that at least one data structure stored in memory is to be shared among a plurality of concurrently running application processes managed by an application engine;
identify, within the application engine, contextual information specifying one or more details regarding different functions that are operating among the plurality of concurrently running application processes;
determine which data structures are currently shareable between a first application process and at least a second application process based on the identified contextual information within the application engine; and
share the data structures of the first application process to at least the second application process.
